(19) United States
(12) Patent Application Publication
(10) Pub. No.: US 2025/0265919 A1
(43) Pub. Date: Aug. 21, 2025

(54) WALL PLATE FOR SMOKE ALARM CONTROL

(71) Applicant: Benjamin Popa, Thompsonville, MI (US)

(72) Inventor: Benjamin Popa, Thompsonville, MI (US)

(21) Appl. No.: 19/054,329

(22) Filed: Feb. 14, 2025

Related U.S. Application Data
(60) Provisional application No. 63/555,217, filed on Feb. 19, 2024.

(51) Int. Cl. G08B 25/00; G08B 17/10

(52) U.S. Cl. CPC G08B 25/008; G08B 17/10

(57) ABSTRACT

A push-to-test control panel for controlling a single or a plurality of smoke alarms including an outlet cover for mounting to an outlet box or low voltage outlet box and a circuit board disposed on a back surface of the outlet box. The push-to-test control panel is wired to at least one smoke alarm. Depressing of the first button tests initiates a test or, if the test has been initiated, depressing of the first button stops the test. A time period for the test is controlled by the circuit board to stop testing after an established period of time. The second button silences an alarm function for a period of time as established by the circuit board. The push-to-test device may include an emergency button for triggering a strobe light or other alarm on the exterior of a house for easy identification of the house for emergency responders.

### CROSS-REFERENCE TO RELATED APPLICATIONS

This application is a Utility Patent application claiming priority to U.S. Provisional Patent Application Ser. No. 63/555,217, filed on Feb. 19, 2024, which is incorporated by reference herein in its entirety.

COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### 1. Field of the Invention

The invention relates to the field of home safety and, more particularly, to control systems for simultaneously controlling multiple smoked detectors or other home safety devices from a user accessible location.

### 2. Description of Related Art

Smoke detectors are widely recognized as crucial safety devices in residential and commercial buildings. These devices are designed to detect the presence of smoke, typically produced by fire, and alert occupants to potential danger. Over the years, smoke detector technology has evolved to become more reliable and effective in protecting lives and property.

Traditional smoke detectors are often installed on ceilings or high on walls, making them difficult to access for routine maintenance and testing. This placement, while effective for smoke detection, can create challenges for users who need to interact with the devices. Regular testing of smoke detectors is recommended to ensure they are functioning properly, but the inconvenient location of test buttons on ceiling-mounted units can discourage users from performing these checks as frequently as advised.

In addition to testing concerns, false alarms are a common issue with smoke detectors. Cooking activities, steam from showers, or dust can sometimes trigger alarms unnecessarily. When this occurs, silencing the alarm quickly becomes a priority to reduce disruption and prevent occupants from becoming desensitized to the warning sound. However, reaching a ceiling-mounted detector to silence it can be challenging, especially for individuals with limited mobility or in multi-story buildings.

The interconnected nature of modern smoke detector systems, while beneficial for comprehensive building coverage, can exacerbate these issues. When one detector is triggered, all connected units typically sound the alarm. This feature enhances safety by alerting occupants throughout a structure, but it also means that silencing false alarms or conducting tests affects the entire system.

There is a growing interest in improving the user interface and accessibility of smoke detector controls. Bringing essential functions such as testing and silencing to a more convenient location could potentially increase compliance with recommended testing schedules and provide quicker response times to false alarms. However, any solution must maintain or enhance the primary safety functions of the smoke detection system.

As building codes and safety standards continue to evolve, there is an ongoing need for innovations that balance the effectiveness of smoke detection systems with user-friendly operation. Addressing these challenges could lead to improved overall safety outcomes by encouraging more frequent testing and reducing the likelihood of disabled detectors due to nuisance alarms.

Currently the state of the art includes smoke detectors and smoke alarms that are wired (with or without a battery as backup) and wireless (using a battery supply power). Both have manufacturer recommendations to test operational capabilities with periodic testing of the detector and battery supply. Wired systems may be interconnected where the smoke detectors work in cohort with one another based on the wiring system. The use of 3 wires facilitates power and communication between devices, where 1 wire for 120 VAC (hot, commonly a black wire) provides power, a second wire common/neutral commonly a white wire) provides a return path for 120 VAC, and a third wire for interconnected systems (commonly red) provides a communication line between smoke detectors on that circuit. Once installed, access to the controls on the smoke detector itself may be difficult to access due to placement at ceiling heights.

### SUMMARY OF THE INVENTION

Bearing in mind the problems and deficiencies of the prior art, it is therefore an object of the present invention to provide a control panel wired within the circuit of the smoke detectors to facilitate easy access by the consumer for control of the installed smoke alarms.

It is another object of the present invention to provide a control of the smoke detectors to allow testing of the alarms for proper functionality.

It is another object of the present invention to provide a control of the smoke detectors to allow testing of the alarms for the condition of the backup battery on the alarms.

A further object of the invention is to provide a control to mitigate alarms when a false alarm is triggered, as exemplified with burning food when cooking.

A further object of the invention is to provide easy access to the control of smoke alarms where one may walk over and, without getting a chair or ladder, without carrying around a ladder to each room, and test smoke detectors one by one. This will hopefully encourage people to test their smoke detectors more often and ideally be implemented into wiring code standards.

Still other objects and advantages of the invention will in part be obvious and will in part be apparent from the specification.

The above and other objects, which will be apparent to those skilled in the art, are achieved in the present invention which is directed a push-to-test control panel. The push-to-test control panel includes an installation panel, a circuit board inside the panel, and two buttons mounted for access on the outside of the panel. The circuit board may be installed to smoke alarms, with placement is at conventional heights of light-switch installations for easy access for the control and test of smoke alarms. One button may be used for testing of smoke alarms, initiating and/or stopping a test; where an initial press of the button initiates a test; the circuit board controls the time of the test in order for the user to confirm functionality of installed alarms. A second press of the button may manually stop the testing sequence. A second button silences an ongoing alarm, where an initial press may deactivate smoke alarm functionality for a period of time as controlled by the circuit board.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 (prior art) shows a conventional smoke detector with a button to test and silence the device;

FIG. 2 shows a front view of a push-to-test device with mounting plate and buttons to a) test detectors and b) silence detectors in the event of a false alarm;

FIG. 3 shows a diagram of a circuit where the push-to-test device is installed with smoke alarms. Placement may be the initial, mid or terminal points of the circuit;

FIG. 4 shows a diagram of a push-to-test device which includes an emergency button; and

FIG. 5 shows a front view of another embodiment of the push-to-test device.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; Band C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The terms “smoke detector”; “smoke alarm”, “detector” and “alarm” are used interchangeably to mean an installed device to monitor air conditions and execute audible alarms in the presence of smoke to the instant invention.

Prior to a discussion of the preferred embodiment of the invention, it should be understood that the features and advantages of the invention are illustrated in terms of gaining easy access to the controls of an installed set of smoke detectors.

The present disclosure relates to a push-to-test device for controlling smoke alarms in residential or commercial buildings. This device may provide a convenient and accessible means for testing and silencing interconnected smoke alarms. In some cases, the push-to-test device may be installed at a conventional light switch height, allowing users to easily interact with the smoke alarm system without the need for ladders or other elevation aids.

The push-to-test device may offer several advantages over traditional smoke alarm control methods. For instance, the device may enable users to test multiple interconnected smoke alarms simultaneously from a single, easily accessible location. This feature may encourage more frequent testing of smoke alarms, potentially improving overall safety in buildings where the device is installed.

In addition to testing capabilities, the push-to-test device may also provide a means to silence false alarms quickly and safely. This functionality may be particularly useful in situations where cooking smoke or other non-emergency conditions trigger the alarm system. By allowing users to temporarily silence the alarms from a convenient location, the device may help reduce the likelihood of users disabling their smoke alarms out of frustration with frequent false alarms.

The push-to-test device may be designed to integrate seamlessly with existing smoke alarm wiring systems, potentially simplifying installation and compatibility with various smoke alarm models. This integration may allow the device to control multiple smoke alarms throughout a building, enhancing the overall effectiveness and usability of the smoke alarm system.

In some cases, the push-to-test device may incorporate additional safety features, such as visual indicators or emergency alert capabilities. These features may further enhance the utility of the device in emergency situations, potentially improving response times and overall safety outcomes.

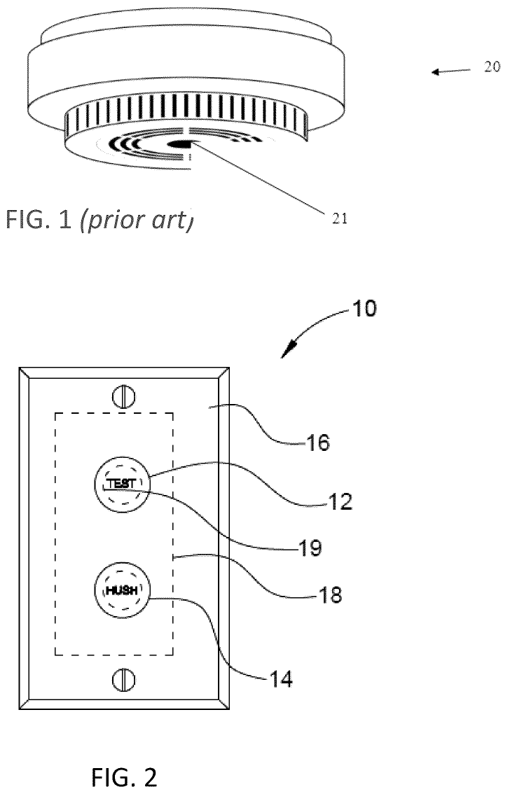

In some cases, a push-to-test unit 10 may be provided for controlling smoke alarms in residential or commercial buildings. FIG. 1 illustrates an exemplary embodiment of the push-to-test unit 10. The push-to-test unit 10 may include an outlet cover 16 configured as a single gang switch plate or outlet cover. The outlet cover 16 may be designed for mounting on a wall at a conventional light switch height, providing easy access for users.

The push-to-test unit 10 may incorporate a circuit board 18. In some implementations, the circuit board 18 may be disposed on a back surface of the outlet cover 16. The circuit board 18 may contain electronic components and circuitry necessary for the operation of the push-to-test unit 10.

FIG. 1 (prior art) shows a conventional smoke detector 21 with a button 21 to test and silence the device.

As shown in FIG. 2, the push-to-test unit 10 may feature two buttons arranged vertically on the front surface of the outlet cover 16. These buttons may provide user interface controls for interacting with the interconnected smoke alarm system. The presence of two distinct buttons may allow for separate functionalities, such as testing and silencing alarms, to be easily accessible to users.

The overall structure and placement of the push-to-test unit 10 may offer advantages in terms of accessibility and ease of use. By mounting the unit at a conventional light switch height, users may interact with the smoke alarm system without the need for ladders or other elevation aids, potentially encouraging more frequent testing and proper management of false alarms.

In some cases, the push-to-test unit 10 may include a first button 12 positioned in a first opening 19 of the outlet cover 16. The first button 12 may be configured to initiate a testing sequence for connected smoke detectors. As shown in FIG. 2, the first button 12 may be circular in shape and may be colored red for easy identification. The first button 12 may be labeled with the word “TEST” to clearly indicate its function to users.

The first button 12 may be electrically connected to the circuit board 18, allowing the push-to-test unit 10 to communicate with the interconnected smoke detectors when the first button 12 is activated. In some cases, the first button 12 may be designed to trigger a testing sequence when pressed and held for a specific duration, such as three seconds. This design may help prevent accidental activation of the testing sequence.

When the first button 12 is pressed and held for the specified duration, the push-to-test unit 10 may send a signal through the interconnected wiring to all functioning smoke detectors in the system. This signal may cause the smoke detectors to sound their alarms for a predetermined period, such as 120 seconds. The extended alarm duration may allow users sufficient time to verify that all smoke detectors in the building are functioning correctly.

In some cases, the testing sequence initiated by the first button 12 may be cancelable. For example, if a user wishes to end the test before the predetermined alarm duration has elapsed, they may press the first button 12 again to cancel the test. This feature may provide users with greater control over the testing process and may be particularly useful in larger buildings with numerous smoke detectors.

The placement of the first button 12 on the push-to-test unit 10, which may be installed at a conventional light switch height, may allow users to easily and safely initiate smoke detector tests without the need for ladders or other elevation aids. This accessibility may encourage more frequent testing of smoke detectors, potentially improving overall fire safety in buildings where the push-to-test unit 10 is installed.

### Second Button: Hush Function

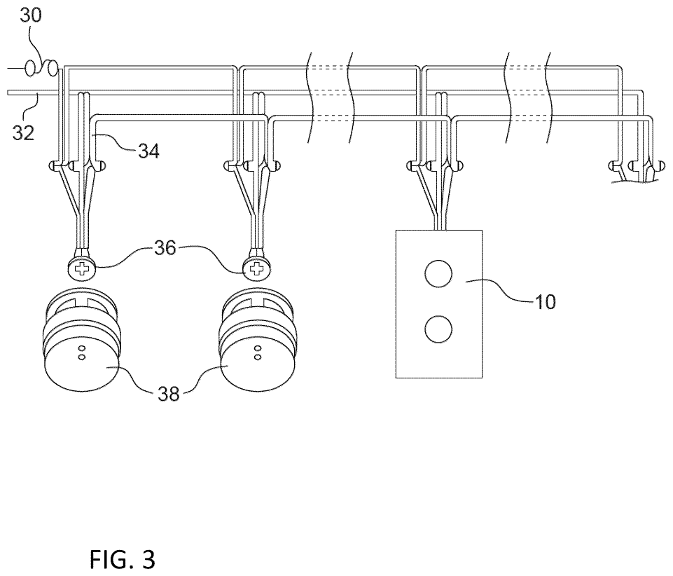

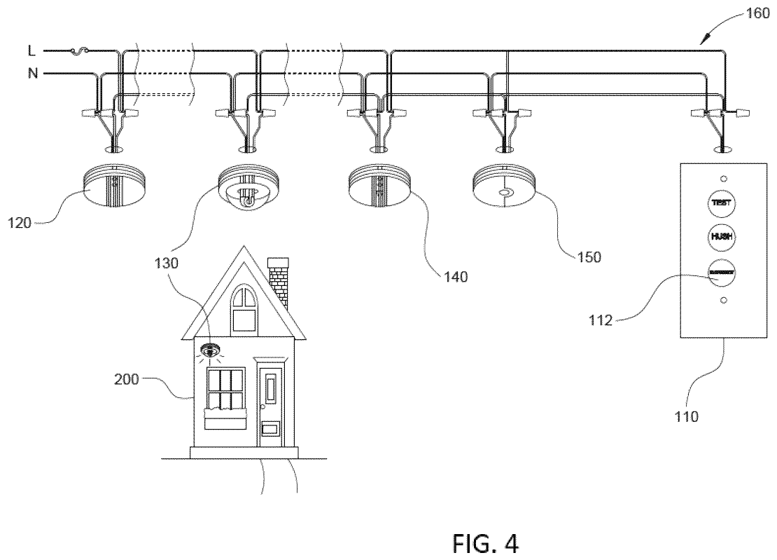

In some cases, the push-to-test unit 10 may be wired to a series of smoke detectors 38 using a standardized wiring configuration commonly employed in residential buildings. FIG. 3 illustrates an exemplary wiring diagram for interconnecting the push-to-test unit 10 with multiple smoke detectors 38.

The wiring configuration may utilize three main conductors: a hot lead 30, a neutral/common wire 32, and a signal wire 34. Each of these wires may serve a specific function in the interconnected system.

In some implementations, the hot lead 30 may provide power to the push-to-test unit 10 and the smoke detectors 38. The hot lead 30 may typically be a black wire in residential wiring systems, although other colors may be used in different regions or applications. The neutral/common wire 32 may serve as the return path for the electrical circuit. In residential wiring, the neutral/common wire 32 may often be white, but again, color conventions may vary. The signal wire 34 may facilitate communication between the push-to-test unit 10 and the smoke detectors 38. This wire may enable the transmission of test signals, alarm signals, and other control information throughout the interconnected system. In some residential wiring systems, the signal wire 34 may be red, similar to wires used in 3-way switch installations.

The push-to-test unit 10 may be wired in series or parallel with the smoke detectors 38 using the same three-wire configuration. This arrangement may allow the push-to-test unit 10 to communicate with and control all connected smoke detectors 38 in the system. In some cases, connectors 36 may be used to facilitate the electrical connections between the smoke detectors 38 and the wiring system. These connectors 36 may help maintain consistent wiring polarity throughout the system, ensuring proper communication and operation between all components. The circuit board 18 of the push-to-test unit 10 may be designed to interface with this three-wire configuration, allowing it to send and receive signals through the signal wire 34 while drawing power from the hot lead 30 and neutral/common wire 32.

By utilizing the same wiring configuration as the smoke detectors 38, the push-to-test unit 10 may be seamlessly integrated into existing residential smoke detector circuits. This compatibility may simplify installation and allow for easy retrofitting of the push-to-test unit 10 into homes with pre-existing interconnected smoke detector systems. In some cases, a push-to-test device 110 may be provided with enhanced functionality beyond testing and silencing smoke alarms. FIG. 4 illustrates an exemplary embodiment of the push-to-test device 110 with additional features and connections to various alarm components.

The push-to-test device 110 may include an emergency button 112. The emergency button 112 may be positioned on the front face of the push-to-test device 110, providing easy access for users in emergency situations. The emergency button 112 may be electrically connected to the circuit board of the push-to-test device 110, allowing for integration with other alarm components.

The push-to-test device 110 may be connected to multiple alarm components through a wiring configuration. This configuration may include connections to a smoke alarm 120, a strobe light 130, a heat alarm 140, and a carbon monoxide alarm 150. The interconnection of these components may allow for a comprehensive alarm system within a residential structure 200. The wiring configuration for connecting the push-to-test device 110 to the various alarm components may utilize the hot lead, the neutral/common wire, and the signal wire. This three-wire configuration may be consistent with the wiring used for standard smoke detector installations, potentially simplifying integration with existing systems.

The strobe light 130 may be mounted on the exterior of the residential structure 200. The strobe light 130 may be electrically connected to the push-to-test device 110 through the wiring configuration. When the emergency button 112 on the push-to-test device 110 is activated, a signal may be sent through the wiring to activate the strobe light 130. The activation of the strobe light 130 on the exterior of the residential structure 200 may serve as a visual indicator for emergency responders. This feature may help emergency personnel quickly locate the residential structure 200 in urgent situations, potentially reducing response times.

The integration of the smoke alarm 120, heat alarm 140, and carbon monoxide alarm 150 with the push-to-test device 110 may allow for centralized control and monitoring of multiple safety devices. In some implementations, the push-to-test device 110 may be capable of initiating tests or silencing alarms for all connected devices simultaneously.

The enhanced functionality provided by the emergency button 112 and the connection to multiple alarm components may expand the capabilities of the push-to-test device 110 beyond simple smoke alarm control. This expanded functionality may offer users a more comprehensive safety system within the residential structure 200.

In some cases, the push-to-test system may provide comprehensive smoke alarm control and emergency response functionality through the interaction of multiple components. The system may include a push-to-test unit, interconnected smoke detectors, and additional safety devices, all working together to enhance overall safety in residential or commercial buildings.

The push-to-test unit, as shown in FIG. 2, may serve as the central control point for the system. This unit may be installed at a conventional light switch height, allowing users to easily access and operate the device without the need for ladders or other elevation aids. The push-to-test unit may feature two buttons: one for initiating smoke detector tests and another for silencing false alarms.

In some implementations, the push-to-test unit may be wired to a series of smoke detectors using a standardized three-wire configuration, as illustrated in FIG. 3. This wiring arrangement may allow the push-to-test unit to communicate with and control all connected smoke detectors simultaneously. When a user activates the test button on the push-to-test unit, a signal may be sent through the interconnected wiring, causing all functioning smoke detectors to sound their alarms for a predetermined period. This feature may enable users to verify the proper operation of all smoke detectors in the building from a single, convenient location.

The system may also incorporate a silencing function, which may be activated using the second button on the push-to-test unit. In the event of a false alarm, such as those triggered by cooking smoke, users may quickly silence the interconnected smoke detectors by pressing this button. This functionality may help reduce the likelihood of users disabling their smoke alarms out of frustration with frequent false alarms, potentially improving overall safety.

In some cases, the push-to-test system may include additional safety features and components, as depicted in FIG. 4. The system may incorporate various alarm devices, such as smoke alarms, heat alarms, and carbon monoxide alarms, all interconnected with the push-to-test unit. This integration may allow for centralized control and monitoring of multiple safety devices throughout a building.

The system may also include an emergency button on the push-to-test unit, which may be used to alert emergency services in critical situations. When activated, this button may trigger a strobe light mounted on the exterior of the building. The strobe light may face the road, providing a clear visual signal to guide emergency responders to the location quickly. This feature may be particularly valuable in situations where rapid response times are crucial, such as during medical emergencies or fire incidents.

By combining these various components and functionalities, the push-to-test system may offer a comprehensive approach to building safety. The system may provide users with easy access to smoke alarm testing and silencing functions, while also incorporating additional safety features for emergency situations. This integrated approach may help improve overall safety outcomes by encouraging regular testing of smoke alarms, reducing false alarm frustrations, and potentially decreasing emergency response times.

The instant invention is a device which is wired to a set of smoke detectors in the home, with placement at conventional height of a light switch, providing controls for alarm testing, battery function and silencing smoke alarms in the event of a false alarm being triggered.

The instant invention comprises the following components:
a. A circuit board with wired access to a new or existing smoke alarm circuit
b. A mounted panel sized for electrical wall installations
c. A button to facilitate functional testing
d. A button to facilitate cessation of alarms

The push-to-test device includes a circuit board mounted onto a single gang switch plate or outlet cover, having two buttons. A first button allows the user to test the smoke detectors by pressing and holding the first for three seconds. Depressing of the first button triggers all of the working smoke detectors to sound the alarm for 120 seconds. During this time, the person testing the smoke detectors can walk around the house to verify that all the smoke detectors are functioning correctly. The test can be canceled at any time by pressing the first button (test button) again. The second button is the hush button, which silences the smoke detectors in case of a false alarm. For instance, if someone is cooking and the smoke detector goes off, they can simply press the second button (hush button) on the push-to-test device, which will silence the smoke detectors for 900 seconds or other period of time, giving them time to clear up the issue. The push-to-test device is wired to the interconnected smoke detectors using the same wire as the one used to wire smoke detectors in a residential house. Those with linked smoke detectors benefit from this device. Ideally, it would be mandated by code.

FIG. 1 is indicative of a conventional smoke detector 20 with a test button 21 on the housing of the unit. When installed, access to the button on the smoke alarm itself could be prohibitive due to placement at or near ceiling height.

Referring now to the drawings FIGS. 2-4, and more particularly to FIG. 2, there is shown a single gang wall mounted push-to-test unit 10 with a button to test smoke detectors within the circuit and a button 14 to silence smoke detectors.

FIG. 3 is an illustration of a series of smoke detectors 38 which are wired into a circuit where the hot lead (commonly the black wire) 30 provides power, the neutral/common wires (commonly the white wire) 32 provides the return and the signal wire (commonly the red wire as used with 3-way switch installations) 34 facilitates communication between devices. A connector 36 is commonly utilized to connect the smoke detector 38. The push-to-talk unit 10 is wired to the circuit using the same wiring configuration of hot 30, common 32 and signal 34 wires.

The push-to-test control panel 10 controls a single or a plurality of smoke alarms 38. The control panel 10 includes an outlet cover 16 for mounting to an outlet box or low voltage outlet box and a circuit board 18 disposed on a back surface of the outlet box. The circuit board 18 includes electronic components connected to provide a circuit for providing functionality to the circuit board 18. The control panel includes a first button 12 and a second button 14 mounted in a first opening 19 and a second opening (not labeled) of the outlet cover 16. The push-to-test control panel 10 is wired to at least one smoke alarm 38. Depressing of the first button 12 tests initiates a test or, if the test has been initiated, depressing of the first button 12 stops the test. A time period for the test is controlled by the circuit board to stop testing after an established period of time. The second button 14 silences an alarm function for a period of time as established by the circuit board.

Push to Test Device helps people test and hush their smoke detectors by bringing the test/hush button that is on a smoke detector down to a readily reachable height. Commonly, people do not test smoke alarms at recommended intervals, in part due to a struggle in reaching the test/hush button on the smoke detector. With the push-to-test device, a person may easily and safely test and hush smoke detectors, without added risk of a ladder or chair with a tip-over situation. Instances where false alarms occur, such as during food preparation, the smoke alarms sound created added chaos on top of management of smoke from food preparations. Smoke detector(s) keep going off because the smoke is not cleared. In the event of a false smoke detection, with the push-to-test device connected to smoke detectors and located at manageable height, as with light switch height near kitchens or halls, one can quickly reach the test/hush button and silence the alarm for a predetermined time, giving time to open windows and doors to allow the smoke to clear out. The push-to-test device installed in homes will be much safer by being able to test and hush their smoke detectors from a safe level.

Access at a reasonable height mitigates risk with chairs or ladders used to reach installed smoke detectors. With the push-to-test device conveniently installed and placed at light switch height in hallways or near kitchens, one can quickly check if every detector is functioning properly, ensuring the safety of loved ones. In addition, this device is equipped with a hush button that provides the convenience of silencing the alarm in the event of a false alarm. Simply press the hush button to temporarily silence the alarm until issues are resolved.

FIG. 4 shows a diagram of another embodiment of the push-to-test device 110 which includes an emergency button 112. A wiring harness 160 connects the push to test device 110 with a smoke alarm 120, strobe light 130, heat alarm 140 and carbon monoxide alarm 150. The push to test device 110 may be used as an emergency aid to assist individuals in times of crisis. The device is equipped with an emergency button 112 that can be pressed to alert emergency services in the event of an emergency. For instance, suppose someone is at home and a family member suddenly experiences a heart attack. In that case, emergency services such as the police, fire department, and EMS need to be notified immediately to arrive at the location promptly. However, to enable the emergency responders to reach the location as quickly as possible, they need to locate the address quickly.

The emergency button 112 is placed at light switch height in hallways throughout the home. When the emergency button 112 is pressed, a strobe light 130 on the exterior of the home 200 is activated with the strobe light facing the road. The strobe light illuminates the home, providing a visual signal to emergency responders, allowing them to locate the home quickly and arrive promptly. This rapid response time can make all the difference in saving a life. The push-to-test device design and placement of the emergency button 112 provide a solution to address the problem of locating a home's address during an emergency. The quick and efficient response of the device can help emergency responders to reach the location promptly and provide timely assistance to individuals in need. The push to test device can ensure a higher rate of success in emergency situations and enhance emergency preparedness.

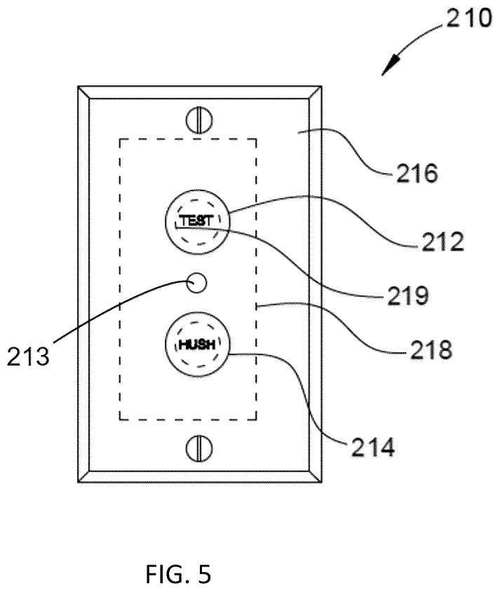

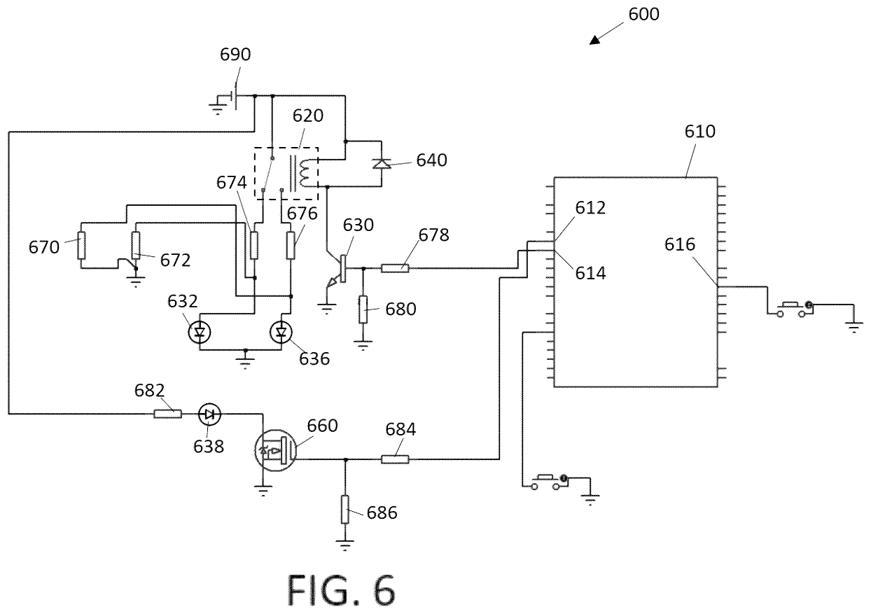

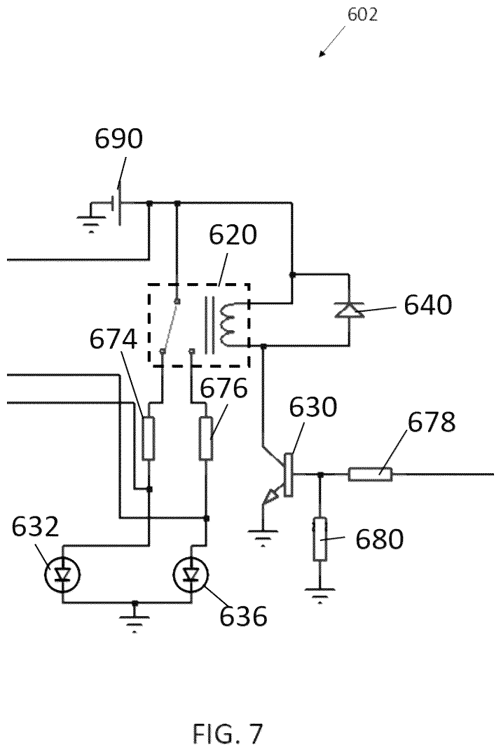

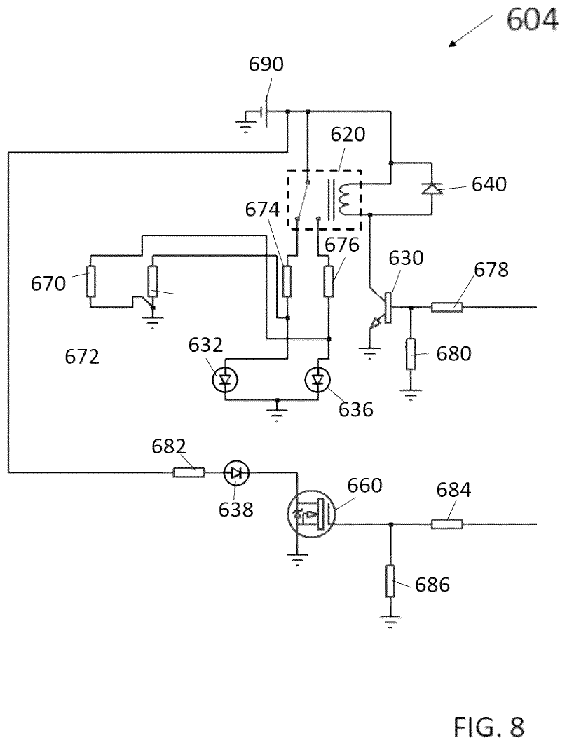

FIG. 5 shows a front view of another embodiment of the push-to-test device. The push-to-test control panel 210 controls a single or a plurality of smoke alarms. The control panel 210 includes an outlet cover 216 for mounting to an outlet box or low voltage outlet box and a circuit board 218 disposed on a back surface of the outlet box. The circuit board 218 includes electronic components connected to provide a circuit for providing functionality to the circuit board 218. The control panel includes a first button 212 and a second button 214 mounted in a first opening 219 and a second opening (not labeled) of the outlet cover 216. An indicator lamp 213 is disposed on the outlet cover 216 and illuminates when a functional alert is triggered. A functional alert is triggered when the push-to-test device senses low voltage output from the battery or a faulty break in the circuit or wire. Alternately, a functional alert is triggered when the push-to-test device has not been tested in a desired amount of time. Alternately, a functional alert is triggered when the push-to-test device senses an electrical problem. Alternately, the indicator lamp 213 may be a bright lamp which illuminates during a power outage to provide area lighting. The push-to-test control panel 210 is wired to at least one smoke alarm. Depressing of the first button 212 tests initiates a test or, if the test has been initiated, depressing of the first button 212 stops the test. A time period for the test is controlled by the circuit board to stop testing after an established period of time. The second button 214 silences an alarm function for a period of time as established by the circuit board.

FIG. 6 shows an example circuit schematic 600 for performing the functions of the push-to-test device and includes a 12 v power source 690, which is preferably a battery. Microchip 610 may be an ATMEGA32 microcontroller, having 40 pins with at least microcontroller connection PA1/ADC1 612, microcontroller connection PA2/ADC2 614 and microcontroller connection PD2/INTO 616. Resistors 670, 672, 674, 676, 680, 682, 684 have a value of 1 k ohm. Resistor 678 has a value of 220 ohms. Resistor 686 has a value of 10 k ohms. Relay 620 includes a magnetic coil having a diode 1N4007 640 or similar wired in parallel. The LEDs 632, 636, 638 are indicator lights for the control system and may illuminate in different colors.

Upon triggering one smoke alarm, a 9 VDC signal (either stepped down from the AC line or from a back-up 9V battery) is applied on the interconnected line that is connected between all the smoke detectors and connected directly to all the alarms inside each detector, therefore if one of them is triggered, all of them are triggered, upon shorting the interconnected line, the interconnected line voltage will be grounded and all the alarms will be turned off. The circuit controls a group of interconnected smoke alarms all at once so that it can be closer to the ground to be easily controlled.

An AVR micro controller uses interrupt and timer peripherals to be able to take input from the two push buttons and time each signal as required in the document where upon pushing the test button for 3 seconds and releasing it, it triggers a signal from the AVR to the switching circuit, upon pushing it again, it stops the testing signal, also when pushing the hush button, it triggers a signal to the MOSFET circuit to hush all alarms for 900 seconds (as mentioned in the requirements document) which is used for hushing false alarms, to bypass the 900 second time and make the alarms work normally again you will have to test it again or wait for the time period to end.

FIG. 7 shows the BJT transistor portion 602 of the circuit 600 shown in FIG. 6 and includes BJT transistor 630, which takes the signal from the AVR controller and controls relay 620. The relay is used to switch the interconnected line between open circuit and 9 VDC signal, where the LED 636, preferably green, is used to simulate the interconnected line. Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents. Where when the controller signals the transistor, the relay is switched to connect the open interconnected line to the 9 VDC which came from the AC line stepped down to 9 VDC. If the test button is depressed again, the AVR controller signals the circuit and releases the interconnect line to be opened to not interfere in the smoke alarm signals and wait for a new signal.

FIG. 8 shows the MOSFET circuit 604 portion of circuit 600 including MOSFET 660 used to connect the interconnect line to the ground when hushing the smoke alarms, so the interconnect line would be connected to both circuits, and upon hushing, the AVR signals the first circuit to be not connected to the 9 VDC and signals the MOSFET circuit to short the interconnect line which is also simulated using LED 638. When the MOSFET circuit is triggered, the RELAY circuit will be opened to allow shorting the line and hushing the alarm. The same mechanism is used with the STROBE light button where upon pushing the button the strobe light is triggered using the MOSFET by putting 9 VDC on the Strobe light line.

The present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A wall-mounted control panel for controlling a plurality of smoke alarms, comprising:
an outlet cover configured for mounting to an outlet box;
a circuit board disposed on a back surface of the outlet cover, the circuit board including electronic components connected to provide functionality;
a first button mounted in a first opening of the outlet cover;
a second button mounted in a second opening of the outlet cover; and
a wiring configuration for connecting the control panel to the at least one smoke alarm;
wherein depressing the first button initiates or stops testing of the at least one smoke alarm for a time period controlled by the circuit board, and wherein depressing the second button silences an alarm function for a period of time established by the circuit board.

2. The wall-mounted control panel of claim 1, wherein the wiring configuration comprises a hot lead, a neutral wire, and a signal wire.

3. The wall-mounted control panel of claim 1, wherein the first button is configured to initiate a test of the at least one smoke alarm when depressed for a predetermined time period.

4. The wall-mounted control panel of claim 3, wherein the predetermined time period is three seconds.

5. The wall-mounted control panel of claim 1, wherein the time period for testing controlled by the circuit board is 120 seconds.

6. The wall-mounted control panel of claim 1, wherein the period of time for silencing the alarm function is 900 seconds.

7. The wall-mounted control panel of claim 1, further comprising an emergency button mounted in a third opening of the outlet cover, wherein the emergency button is configured to activate a strobe light on an exterior of a building when depressed.

8. A method of controlling a plurality of interconnected smoke alarms, comprising:
receiving, at a wall-mounted control panel, a first user input via a first button;
in response to the first user input, initiating a test sequence of at least one smoke alarm connected with the control panel;
receiving, at the wall-mounted control panel, a second user input via a second button; and
in response to the second user input, silencing an alarm function of the at least one smoke alarm for a predetermined period of time.

9. The method of claim 8, wherein the first user input comprises pressing and holding the first button for a predetermined time period.

10. The method of claim 9, wherein the predetermined time period is three seconds.

11. The method of claim 8, wherein the test sequence comprises causing the at least one smoke alarm to sound for a predetermined test duration.

12. The method of claim 11, wherein the predetermined test duration is 120 seconds.

13. The method of claim 8, wherein the predetermined period of time for silencing the alarm function is 900 seconds.

14. The method of claim 8, further comprising:
receiving, at the wall-mounted control panel, a third user input via an emergency button; and
in response to the third user input, activating a strobe light on an exterior of a building.

15. A smoke alarm control system, comprising:
a plurality of smoke alarms; and
a wall-mounted control panel wired with the plurality of smoke alarms, the control panel including:
a first user interface element for initiating a test sequence of the plurality of smoke alarms,
a second user interface element for silencing an alarm function of the plurality of smoke alarms, and
a circuit board configured to control timing of the test sequence and a duration of the alarm silencing in response to user inputs received via the first and second user interface elements.

16. The smoke alarm control system of claim 15, wherein the first user interface element is a button configured to initiate the test sequence when pressed and held for a predetermined time period.

17. The smoke alarm control system of claim 16, wherein the predetermined time period is three seconds.

18. The smoke alarm control system of claim 15, wherein the second user interface element is a button configured to silence the alarm function for a predetermined duration when pressed.

19. The smoke alarm control system of claim 18, wherein the predetermined duration for silencing the alarm function is 900 seconds.

20. The smoke alarm control system of claim 19, further comprising a strobe light mounted on an exterior of a building and electrically connected to the wall-mounted control panel, wherein the control panel includes an emergency button configured to activate the strobe light when pressed.
